(19) United States
(12) Patent Application Publication
(10) Pub. No.: US 2009/0196258 A1
(43) Pub. Date: Aug. 6, 2009

(54) SWITCHING OF AN INFRASTRUCTURE-LESS NETWORK TO A FIXED-INFRASTRUCTURE NETWORK

(75) Inventors: Luis Ignacio Escobar Sanz, Paris (FR); Deborah Baruch, Malakoff (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 12/302,521

(22) PCT Filed: Jun. 1, 2007
(86) PCT No.: PCT/FR2007/051368

§ 371 Date: Nov. 26, 2008

(30) Foreign Application Priority Data
Jun. 6, 2006 (FR) 0652023

(51) Int. Cl. H04W 36/00

(52) U.S. Cl. 370/332

(57) ABSTRACT

A communication session between a first terminal and a second terminal is switched from a first network with no fixed infrastructure to a second network with a fixed infrastructure upon degradation on a first transmission channel between the terminals in the first network. In each terminal, a controller detects a degradation on the first transmission channel and stores the latest data received from the other terminal. An interface transmits an invitation message including connection parameters relative to a second transmission channel to the other terminal via one of the networks if the degradation is estimated as permanent. The second transmission channel from the other terminal is established through the second network so that the terminals are connected via the second network to thereby continue the communication session depending on the stored latest received data.

The present invention relates to a data channel switching between two equipments from a wireless local area network with no fixed infrastructure to a network with a fixed infrastructure without interrupting an ongoing communication session relating to voice and/or data between the two equipments.

More particularly, the invention relates to a switching of data channels between two equipments from a wireless local area network with no fixed infrastructure, referred to as ad hoc network meeting an IEEE 802.11x standard and the WiFi (“Wireless Fidelity”) certification label, or of the Bluetooth or infrared type, to a fixed-infrastructure network such as a GSM/GPRS (“Global System for Mobile communications/General Packet Radio Service”) or UMTS (“Universal Mobile Telecommunications System”) network and/or the internet or an intranet.

The progress of wireless local area network technologies makes it possible to build ad hoc networks formed by terminals directly interacting therebetween with no intervention of a centralizing equipment, such as an access point connected to a server, or such as a base station connected to a station controller.

Today, when two terminals in an ad hoc network move away from one another, and become out of radio range, a loss of connection between the two terminals disadvantageously interrupts a communication session between the two terminals. For example, a video game play initiated in an ad hoc mode between the two terminals is interrupted if the two terminals get out of radio range one relative to the other.

The current state of the art does not allow for the previous communication session to be restored and requires establishing another communication session between the two terminals via a fixed-infrastructure network.

In order to overcome such a disadvantage, a solution would be that a centralized server would decide on the communication switching between the two terminals, such a decision being unadapted to the ad hoc network.

The present invention overcomes the above mentioned disadvantages.

A method for switching a communication session between at least a first terminal and a second terminal from a first network with no fixed infrastructure to a second network with a fixed infrastructure upon degradation on a first transmission channel between the two terminals in the first network, the two terminals each including communication means relative to the first and second networks, is characterized in that it includes in each terminal the following steps of:

detecting a degradation on the first transmission channel and storing latest data received from the other terminal,

transmitting an invitation message including connection parameters relative to a second transmission channel to the other terminal via one of the first and second networks if the degradation is estimated as permanent, and

establishing the second transmission channel from said other terminal through the second network so that the terminals are connected via the second network to thereby continue the communication session depending on the stored latest received data.

The method of this invention has this advantage to manage the switching of data channels between two terminals from a network with no fixed infrastructure, such as an ad hoc network, to a network with a fixed infrastructure without interrupting an ongoing communication session between the two terminals. Monitoring the first transmission channel in the infrastructure-less network so as to detect therein a predetermined degradation on the first transmission channel makes it possible to anticipate any irreversible communication session interruption according to the prior art. Continuing the ongoing communication session occurs through storing data being again transmitted as soon as the second transmission channel is established, thereby avoiding interrupting the communication session.

According to a feature of this invention, if the first transmission channel is not interrupted, the invitation message is transmitted via the first network. In the opposite case, the invitation message is transmitted via the second network.

According to another feature of this invention, detecting degradation on the first transmission channel comprises determining the mean of a quality index in said first transmission channel and comparing the determined mean with at least one threshold.

Detecting degradation on the channel depending on a mean of the quality index of the channel has the advantage that it avoids taking into consideration erroneous measurements resulting from passing through an obstacle between the two terminals.

According to a feature of the invention, detecting degradation on the first transmission channel comprises:

determining the mean of a quality index of said first transmission channel in a first evaluation period as long as the determined mean is higher than a first threshold,

determining the mean of the quality index of said first transmission channel and storing latest data received from the other terminal in a second evaluation period lower than the first evaluation period as long as the determined mean lies between the first threshold and a second threshold lower than the first threshold, and

determining the mean of the quality index in a third evaluation period lower than the second evaluation period as long as the determined mean lies between the first and second thresholds,

the invitation message being transmitted via the first channel if the quality index mean determined in the third evaluation period lies between the second threshold and a third threshold lower than the second threshold, the invitation message being transmitted via the second network if the quality index mean determined in the third evaluation period is lower than the third threshold, and the second transmission channel being established through the second network if the quality index mean determined in the third evaluation period is lower than the second threshold.

The invention relates also to a terminal including communication means relative to a first network with no fixed infrastructure and a second network with a fixed infrastructure for switching a communication session between said terminal and another terminal from the first network to the second network upon degradation on a first transmission channel between the two terminals in the first network. The terminal is characterized in that it includes:

means for detecting a degradation on the first transmission channel,

means for storing latest data received from the other terminal,

means for transmitting an invitation message including connection parameters relative to a second transmission channel to the other terminal via one of the first and second networks if the degradation is estimated as permanent, and

means for establishing the second transmission channel from said other terminal through the second network so that the terminals are connected via the second network to thereby continue the communication session depending on the stored latest received data.

Finally the invention relates to a computer program including instructions performing a method of the invention when said instructions are executed by a processor.

Other features and advantages of the present invention will become more apparent from reading the following description of several embodiments of the invention given as non limitative examples, with reference to the corresponding appended drawings, wherein:

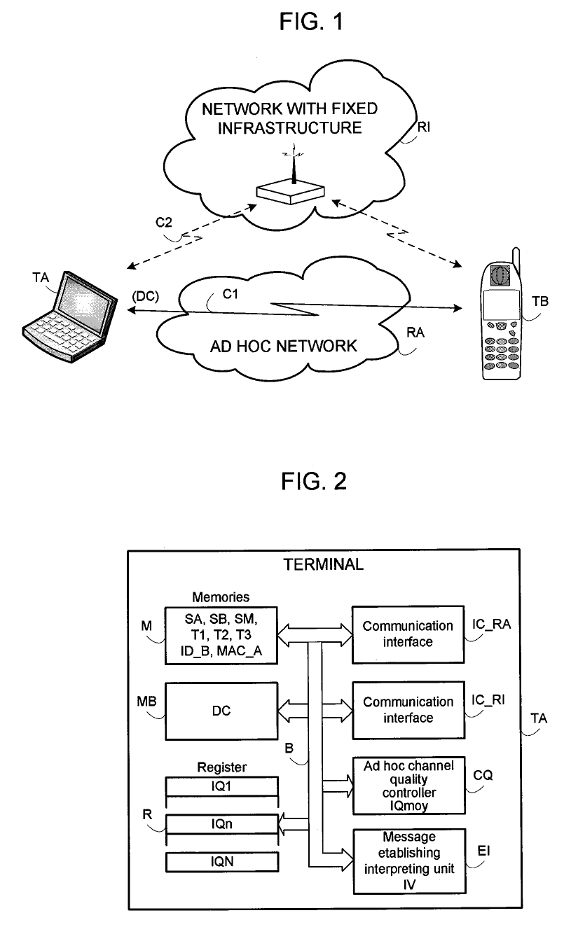

FIG. 1 is a schematic block diagram of a system for switching a network with no fixed infrastructure to a network with a fixed infrastructure;

FIG. 2 is a schematic block diagram of a terminal according to the invention; and

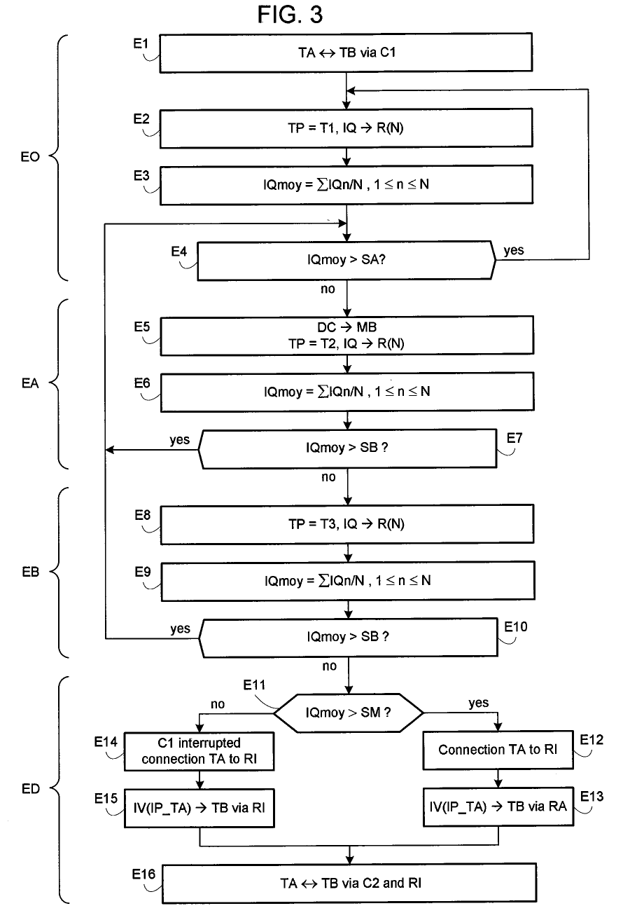

FIG. 3 is an algorithm of a method for switching a network with no fixed infrastructure to a network with a fixed infrastructure according to the invention.

Referring to FIG. 1, a switching system includes at least two terminals TA and TB having initially started a communication session via a first data transmission channel C1 in a network with no fixed infrastructure, called ad hoc network RA in the remaining description. The communication session consists in transmitting data packets DC for example relative to voice. Upon a degradation in the ad hoc channel C1, as a result, for example, of the two terminals moving away from one another, or the two terminals being separated by an obstacle or even, because of interferences in the channel, a second data transmission channel C2 is established between the two terminals in a network RI with a fixed infrastructure so as to continue the ongoing communication session.

The ad hoc network RA is a wireless local area network with no fixed infrastructure wherein several terminals communicate directly between them spontaneously with no intervention of any communication centralization equipment such as an access point or terminal or even a base station. The ad hoc network is for example a wireless local area network with a link of the IEEE 802.11x, Bluetooth or infrared type.

The fixed-infrastructure network RI comprises one or more communication centralization equipments through which communications transit between the terminals covered by the network RI. The network RI is managed by an operator and is, for example, a radiocommunication network such as a GSM/GPRS network, an UMTS network, the internet or an intranet, or such as an array of several of such fixed-infrastructure networks.

The terminal TA, TB is able to communicate through the ad hoc network RA and through the fixed-infrastructure network RI, and is for example a laptop computer TA, a mobile radio terminal TB or a communicating personal assistant.

A terminal is shown on FIG. 2 as functional blocks, the majority of which provide functions relating to this invention and can correspond to software modules and/or material components. Such a terminal is denoted by TA although any other terminal of the ad hoc network such as the terminal TB has equivalent functional blocks.

The terminal TA includes a first communication interface IC_RA, a second communication interface IC_RI, an ad hoc channel quality controller CQ, an invitation message establishing and interpreting unit EI, memories M and MB, and a register R. A specific unit such as the terminal processing central unit, not shown in FIG. 2, characterizes the terminal. All the functional blocks of the terminal TA are linked by a bidirectional bus B.

The first communication interface IC_RA manages the first transmission channel C1 for communicating data packets DC between the terminal TA and the terminal TB in the ad hoc network RA.

The second communication interface IC_RI manages the second transmission channel C2 for communicating data packets DC between the terminal TA and the terminal TB in the network RI.

The controller CQ controls the quality of the ad hoc channel C1 through a periodic evaluation of a quality index IQ of the ad hoc channel C1. The quality index IQ is for example the signal to noise ratio SNR between the power of a signal received by the terminal TA via the transmission channel C1 and the power of the noise received by the terminal TA. Another exemplary index IQ is the power of the signal received by the terminal. In the controller CQ, a mean value IQmoy of such a quality index is determined depending on previously recorded index values during a predetermined period and can be compared with state thresholds SA, SB and SM such as SA>SB>SM in order to control the state of the quality in the transmission channel C1. If the quality of the channel is estimated as too low, the controller CQ activates the switching of the communication from the network RA to the network RI. The state thresholds SA, SB, SM will be defined referring to FIG. 3.

Upon switching of a communication, the unit EI of the terminal TA establishes a communication switching invitation message IV to be transmitted to the terminal TB for inviting it to switch to the network RI. The invitation is transmitted via the network RA or the network RI depending on the degradation state of the channel C1. Upon receipt of the invitation message IV, the unit EI of the terminal TB interprets the invitation message and either replies to it or does not response to it.

The memory M comprises the state thresholds SA, SB and SM pre-programmed and configurable by the manufacturer of the terminal TA and to be compared with the mean value IQmoy of the quality index so as to detect degradation on the channel C1 and to activate the switching. In the memory M, durations T1, T2, T3 configurable and relative to an evaluation period TP of the quality of the channel more or less short depending on the degradation state of the channel C1 are also pre-programmed. The memory M still contains an access identifier ID_B for accessing to the terminal TB and a fixed identifier MAC_A of the terminal TA. The access identifier ID_B is for example the phone number relative to the terminal TB as a mobile radio telephone and allows accessing to the terminal TB so as to establish a communication session with the terminal TB. The fixed identifier MAC_A of the terminal TA is an identifier relative to the ad hoc network such as an identity address fixed by the manufacturer of the terminal TA in the case of a Bluetooth network, an MAC (“Medium Access Control”) address in the case of a network of IEEE 802.1xx type or an IP address fixed by the user. The identifier MAC_A is transmitted to the terminal TB when the channel C1 is established for exchanging data packets DC during the communication session in the transmission channel C1 and is associated with a connection identifier selected by the user of the terminal TB.

The memory MB is considered as a buffer memory, which, upon degradation detection, stores data packets DC to be transmitted to the other terminal so as to transfer them to it as soon as the second transmission channel C2 is established.

The register R comprises N cells and functions as a FIFO stack (“First In First Out”). The last cell of the register R stores the value IQN of the quality index previously recorded in each period TP, after successively previously recorded values of the quality index IQ1 to IQN−1 have been shifted by one cell towards the first cell of the register R, the oldest value preceding the value IQ1 being deleted.

The switching method according to the invention is shown on FIG. 3 in association with four quality states of the ad hoc transmission channel C1 which are successively an optimization state EO when the quality of the channel C1 is good, a warning state EA when the channel C1 is submitted to a first degradation, a switching state EB when the channel C1 is submitted to a second degradation and a disconnection state ED when the second degradation on the channel C1 is considered as permanent. The method is described when the terminal TA represented on FIG. 2, as a “master” terminal, decided to request a communication with the terminal TB, knowing that the method is carried out similarly in the terminal TB.

The optimization state EO comprises the steps E1 to E4.

In step E1, upon the establishment of the transmission channel C1 between the terminal TA and the terminal TB in the ad hoc network RA, the terminal TA transmits its fixed identifier MAC_A to the terminal TB and in response, the terminal TB transmits its fixed identifier MAC_B to the terminal TA for exchanging data packets DC via the channel C1. The controller CQ of the terminal TA triggers the quality control in the channel C1.

In the evaluation period TP equal to the duration T1 relative to the optimization state EO and stored in the memory M of the terminal TA, the controller CQ evaluates the value of the quality index IQ in the channel C1, in step E2, and records it in the last cell N of the register R after a shift of other previously recorded values of the quality index towards the first cells. If no value has been recorded since the channel C1 has been established, the cells of the register R are at zero.

In step E3, the controller CQ evaluates the quality of the channel C1 by determining the mean IQmoy of N latest values of the quality index recorded in the register R.

If, in step E4, the determined mean value IQmoy is higher than the threshold SA, the so-called warning threshold, read in the memory M of the terminal TA, then the controller CQ again performs steps E2 and E3 during the next evaluation period TP.

In the opposite case, the controller CQ performs steps E5 to E7 relative to the warning state EA of the channel C1.

In step E5, the controller controls in the buffer memory MB the start of the storage of received data packets DC transmitted by the terminal TB and modifies the value of the evaluation period TP to the duration T2 lower than the previous duration T1. Such a modification involves an increase of the control frequency of the quality of the channel so as to detect a possible increase of the degradation on the channel. The data packets received and stored in the memory MB are normally processed by the terminal TA as long as the communication session is not suspended. Storing the data DC in the memory MB ensures the continuity of the communication session when the channel C1 is suddenly interrupted. In the evaluation period TP equal to the duration T2, the controller CQ evaluates the value of the quality index IQ in the channel C1 and records it in the last cell N of the register R after a shift of other previously recorded values of the quality index towards the first cells.

In step E6, the controller CQ evaluates the quality of the channel C1 by determining the mean value IQmoy of the N values of the quality index recorded in the register R.

If, in step E7, the determined mean value IQmoy is higher than the second threshold SB, the so-called switching threshold, read in the memory M of the terminal TA, then the controller CQ returns to step E4 so as to compare the determined mean value IQmoy with the warning threshold SA and optionally return to the optimal state EO or remain at the warning state EA. This means that the quality of the channel C1 is still acceptable and can still support the exchange of data packets between the two terminals, without requiring a switching to the second channel C2. The controller stops in the memory MB the storage of the data packets DC transmitted by the terminal TB.

If, on the contrary, in step E7, the value IQmoy is lower than the switching threshold SB, the controller CQ performs steps E8 to E10 relative to the switching state EB of the channel C1.

In step E8, the controller CQ modifies the value of the evaluation period TP to the duration T3 significantly lower than the previous duration T2 so as to quickly check whether the degradation on the channel is permanent and is not only a result of, for example, a temporary obstacle between the two terminals.

In the evaluation period TP equal to the duration T3, the controller CQ evaluates the value of the quality index IQ in the channel C1 and records it in the last cell N of the register R after having shifted other previously recorded quality index values towards the first cells.

In step E9, the controller CQ evaluates the quality of the channel C1 by determining the mean value IQmoy of the N values of the quality index recorded in the register R.

If, in step E10, the determined mean value IQmoy is higher than the switching threshold SB, this indicates that the degradation on the channel C1 is temporary, and the controller CQ returns to step E4.

On the other hand, if the mean value IQmoy is lower than the switching threshold SB, the degradation on the channel C1 has become permanent and a switching of the communication from the ad hoc network RA to the fixed-infrastructure network RI should be prepared so as not to interrupt the communication session established in step E1. The controller CQ performs steps E11 to E16 relative to the disconnection state ED of the channel C1.

In step E11, the controller CQ suspends the communication session and compares the mean value IQmoy previously determined in step E9 with the threshold SM, the so-called minimal disconnection threshold.

If the mean value IQmoy is higher than the threshold SM and thus lies between the thresholds SM and SB, the channel C1 is sufficiently degraded to require switching the communication towards the fixed-infrastructure network RI, but has nevertheless a sufficient quality so as not to be interrupted immediately between the two terminals. The controller then establishes a connection with a central equipment of the network RI by activating a context, for example PDP (“Packet Data Protocol”), when the network RI includes a packet-switched network GPRS with mobility and radio access management, so that an identifier belonging to the fixed-infrastructure network, such as an IP (“Internet Protocol”) internet address, denoted IPFA for the terminal TA, is assigned to it in step E12.

In step E13, the unit EI establishes an invitation message IV such that the communication interface IC_RA transmits it via the ad hoc channel C1 to the terminal TB, inviting it to switch towards the network RI so as to establish a second transmission channel C2. The invitation message IV contains connection parameters, including the IPFA address assigned to the terminal TA so as to establish the channel C2 and identify the access identifier ID_B of the terminal TB.

Upon the receipt of the invitation message in step E16, the terminal TB decides or not to establish the second transmission channel C2 with the terminal TA via the network RI for continuing the ongoing communication session by processing the last data packets DC received and stored in its buffer memory MB.

Returning to step Eli, if the mean value IQmoy determined in step E9 is lower than the minimal threshold SM, then the transmission channel C1 is interrupted and the two terminals are out of range.

In step E14, the controller CQ establishes a connection with the central equipment of the network RI activating a context, such as the context PDP, so that an IPFA address is assigned to it.

In step E15, the unit EI establishes an invitation message IV so that the communication interface IC_RI transmits it via the fixed-infrastructure network RI to the terminal TB, inviting it to switch towards the network RI for establishing a transmission channel C2. The invitation message IV contains the IPFA address assigned to the terminal TA and the access identifier ID_B of the terminal TB which is the destination of the message.

If the terminal TB is not connected to the network RI, a server dedicated to the network RI having intercepted the invitation message, transmits it to the terminal TB for example as a short message of the SMS type depending on the access identifier ID_B present in the invitation message IV. While being connected to the network RI, the terminal TB opens a context, such as the context PDP, so as to obtain an IP address, denoted IP_B, for the terminal TB. Then, upon reading the invitation message, the terminal TB decides or not to establish the transmission channel C2 so as to continue the ongoing communication session by processing the last data packets DC stored in its memory MB. Upon the establishment of the channel C2, in step E16, the terminal TB transmits the IP_B address to the terminal TA whose IPFA address is known as included in the invitation message so as to exchange data packets DC through the channel C2.

Simultaneously with the terminal TA, the terminal TB can detect degradation on the channel C1 and perform the steps of the previous method without altering the result of the invention. In such a case, two invitation messages are respectively sent by the two terminals and one of such invitation messages leads a second transmission channel to be established.

The invention described here relates to a method and a terminal. In a embodiment, the steps of the method of the invention are determined by the instructions of a computer program incorporated in the terminal. The program includes program instructions which, when said program is executed in a processor of the terminal, the operation whereof is then controlled by the execution of the program, execute the steps of the method according to the invention.

Consequently, the invention also applies to a computer program, in particular a computer program stored on or in a storage medium readable by a computer and by any data processing device adapted to implement the invention. This program can use any programming language and take the form of source code, object code or an intermediate code between source code and object code, such as a partially compiled form, or any other form desirable for implementing the method according to the invention.

The storage medium can be any entity or device capable of storing the program. For example, the medium can include storage means in which the computer program according to the invention is stored, such as a ROM, for example a CD ROM or a microelectronic circuit ROM, a USB key, or magnetic storage means, for example a diskette (floppy disk) or a hard disk.

Moreover, the information medium can be a transmissible medium such as an electrical or optical signal, which can be routed via an electrical or optical cable, by radio or by other means. The program according to the invention can in particular be downloaded over an Internet type network.

Alternatively, the information medium can be an integrated circuit in which the program is incorporated, the circuit being adapted to execute or to be used in the execution of the method according to the invention.

1. A method of switching a communication session between at least a first terminal and a second terminal from a first network with no fixed infrastructure to a second network with a fixed infrastructure upon degradation on a first transmission channel between said first and second terminals in said first network, said first and second terminals each including communication means relative to said first and second networks, said method including in at least one of said first and second terminals the following steps of:
detecting a degradation on said first transmission channel and storing latest data received from the other terminal,
transmitting an invitation message including connection parameters relative to a second transmission channel to the other terminal via one of said first and second networks if said degradation is estimated as permanent, and
establishing said second transmission channel from said other terminal through said second network so that said first and second terminals are connected via said second network to thereby continue said communication session depending on the stored latest received data.

2. A method as claimed in claim 1, wherein said invitation message is transmitted via said first network if said first transmission channel is not interrupted.

3. A method as claimed in claim 1, wherein said invitation message is transmitted via said second network if said first transmission channel is interrupted.

4. A method as claimed in claim 1, wherein detecting said degradation on said first transmission channel comprises determining a mean of a quality index in said first transmission channel and comparing the determined mean with at least one threshold.

5. A method as claimed in claim 1, wherein detecting degradation on the first transmission channel comprises:
determining a first mean of a quality index of said first transmission channel in a first evaluation period as long as said first mean is higher than a first threshold,
determining a second mean of the quality index of said first transmission channel and storing latest data received from said other terminal in a second evaluation period lower than said first evaluation period as long as the said second mean lies between said first threshold and a second threshold lower than said first threshold, and
determining a third mean of the quality index in a third evaluation period lower than said second evaluation period as long as said third mean lies between said first and second thresholds,
said invitation message being transmitted via said first transmission channel if said third mean lies between third second threshold and a third threshold lower than said second threshold, said invitation message being transmitted via said second network if said third mean is lower than said third threshold, and said second transmission channel being established through said second network if said third mean is lower than said second threshold.

6. A terminal including communication means relative to a first network with no fixed infrastructure and a second network with a fixed infrastructure for switching a communication session between said terminal and another terminal from said first network to said second network upon degradation on a first transmission channel between said terminal and the other terminal in said first network, said terminal including:
a detector arrangement for detecting a degradation on said first transmission channel,
a storage arrangement for storing latest data received from said other terminal,
a transmitter arrangement for transmitting an invitation message including connection parameters relative to a second transmission channel to said other terminal via one of said first and second networks if said degradation is estimated as permanent, and
a processor arrangement for establishing said second transmission channel from said other terminal through said second network so that said terminal and said other terminal are connected via said second network to thereby continue said communication session depending on the stored latest received data.

7. A processor arrangement for executing plural steps in a terminal including communication means relative to a first network with no fixed infrastructure and a second network with a fixed infrastructure for switching a communication session between said terminal and another terminal from said first network to said second network upon degradation on a first transmission channel between said terminal and the other terminal in said first network, said processor arrangement including a storage medium or storage device storing machine readable indicia; the storage medium or storage device, when read causing the processor arrangement to execute the following steps:
detecting a degradation on said first transmission channel and storing latest data received from the other terminal,
transmitting an invitation message including connection parameters relative to a second transmission channel to said other terminal via one of said first and second networks if said degradation is estimated as permanent, and
establishing said second transmission channel from said other terminal through said second network so that said terminal and said other terminals are connected via said second network to thereby continue said communication session depending on the stored latest received data.

8. A storage medium or storage device including machine readable indicia readable by a terminal including communication means relative to a first network with no fixed infrastructure and a second network with a fixed infrastructure for switching a communication session between said terminal and another terminal from said first network to said second network upon degradation on a first transmission channel between said terminal and the other terminal in said first network, the machine readable indicia on said storage medium or storage device including machine readable indicia a computer program including instructions which, when said medium or storage device is loaded and the indicia are read in said terminal, causes the following steps to be executed:
detecting a degradation on said first transmission channel and storing the latest data received from said other terminal,
transmitting an invitation message including connection parameters relative to a second transmission channel to said other terminal via one of said first and second networks if said degradation is estimated as permanent, and
establishing said second transmission channel from said other terminal through said second network so that said terminal and said other terminal are connected via said second network to thereby continue said communication session depending on the stored latest received data.
